(19) United States
(12) Patent Application Publication
(10) Pub. No.: US 2008/0316126 A1
(43) Pub. Date: Dec. 25, 2008

(54) Antenna System for a Radar Transceiver

(76) Inventor: Klaus Voigtlander, Wangen (DE)

Correspondence Address: KENYON & KENYON LLP, ONE BROADWAY, NEW YORK, NY, 10004, US

(21) Appl. No.: 11/792,895

(22) PCT Filed: Nov. 14, 2005
(86) PCT No.: PCT/EP05/55951

§ 371 Date: Apr. 3, 2008

(30) Foreign Application Priority Data
Dec. 9, 2004 (DE) 102004059333.7

(51) Int. Cl. G01S 13/58

(52) U.S. Cl. 343/711

(57) ABSTRACT

An antenna system for a radar transceiver, in particular for ascertaining distance and/or velocity in the surroundings of motor vehicles, at least one antenna being situated on a chip, which includes at least one part of the transmitting and receiving units of the radar transceiver wherein the at least one antenna includes a first part situated on the chip and a second part situated at a distance from the first part and radiation-coupled to the first part.

### FIELD OF THE INVENTION

The present invention relates to an antenna system for a radar transceiver, in particular for ascertaining distance and/or velocity in the surroundings of motor vehicles.

### BACKGROUND INFORMATION

Radar transceivers, i.e., transmitter/receiver modules of this type, are used in the microwave and millimeter wavelength ranges for positioning objects in space or for determining velocities, in particular of motor vehicles. Such radar transceivers are used in particular for driver assistance systems which are intended for determining the distance of another vehicle traveling ahead of the host vehicle and for distance regulation. A radar transceiver of this type transmits ultra-high-frequency signals in the form of electromagnetic waves, which are reflected from the target object, received again by the radar transceiver and further processed, for positioning objects in space and for determining velocities. A plurality of such radar transceivers is often connected to form a single module. When used in automobiles, frequencies in a range of 76 GHz to 81 GHz are used.

German Patent Application No. DE 103 00 955 describes a radar transceiver for microwave and millimeter wavelength applications in which both transmitting and receiving units, as well as an antenna, are situated on a multilayer component. Such a layered construction requires connections which must be designed in such a way as to enable the transmission of ultra-high-frequency RF signals. In order to manufacture such low-loss RF junctions, the manufacturing process of such radar transceivers must meet very high standards.

German Patent Application No. DE 196 48 203 describes a multibeam radar system for motor vehicles. In this radar system the transmitting and receiving units and the antenna are situated on different substrates.

Gunn oscillators are often used for generating the frequencies of 76 GHz to 81 GHz normally used in motor vehicles. Furthermore, GaAs MMICs (monolithic microwave integrated circuits) are often used. More recently, SiGe has also been used as a material for such chips. At the same time, using this material, limiting frequencies higher than 200 GHz are also achievable. Such chips are usually applied to a substrate made of ceramic, LTCC (low-temperature cofired ceramic), to a circuit board, or to a soft board, using flip-chip technology. In addition, these chips are also wired by bonding. Further distributed networks, components, and also antennas are then often also situated on the substrate material. The construction and connection technology is subject to tolerances, expensive, and difficult to control. In addition, it has poor electrical properties at high frequencies.

To avoid these disadvantages, a radar transceiver which has not only a construction which is compact and easy to manufacture, but is also suitable for mounting on essentially known circuit substrates, for example, circuit boards, is described in an unpublished application (not a prior publication) of the Applicant. In this radar transceiver, the transmitting and receiving units are situated on a single chip side-by-side in one plane. Furthermore, at least one patch antenna is situated in the plane of the chip. Due to the electrically effective layer thickness of the SiGe chips, which is in the range of 4 μm to 20 μm, preferably 11 μm, only bandwidths of a few tenths of a percent may be achieved using essentially known patch antennas. In most cases, the chip itself has a thickness of approximately 300 μm.

An object of the present invention is therefore to provide an antenna system for a single-chip radar transceiver having in particular a very thin electrically effective oxide layer, which makes high reproducibility, high reliability, and high bandwidth at high operating frequencies, in particular in a range of 76 GHz to 81 GHz, possible. In addition, such an antenna system must be manufacturable in a simple and therefore cost-effective way.

### SUMMARY OF THE INVENTION

This object is achieved by an antenna system for a radar transceiver, in particular for driver assistance systems for ascertaining distance and/or velocity in the surroundings of motor vehicles according to the present invention.

A basic idea of the present invention is to provide an antenna system on chips having very thin electrically effective layers, which also contain the transmitting and receiving units using printed dipoles having a parallel wire feed, i.e., a differential feed line, instead of patch antennas. The antenna system has a first part situated on the chip and a second part situated at a distance from the first part and radiation-coupled to the first part. By thus dividing the antenna into two parts, an advantageous increase in the bandwidth is achieved. In addition, the radiation resistance is reduced.

In a very advantageous specific embodiment, the second part of the antenna is situated on a radome. This radome preferably forms a housing which completely encapsulates the chip.

In an advantageous exemplary embodiment, the first part is a first transmitting and/or receiving dipole, and the second part is a second transmitting and/or receiving dipole.

The first transmitting/receiving dipole preferably has two halves separated by a gap. It is operated using a parallel wire feed, i.e., a differential feed line or a symmetric feed.

According to an advantageous specific embodiment, the first transmitting and/or receiving dipole has a length approximately equal to the wavelength of the emitted/received electromagnetic radiation.

The second transmitting and/or receiving dipole is an uninterrupted continuous dipole, which has a length approximately equal to one-half of the wavelength of the emitted/received electromagnetic radiation.

For proper field coupling, the second transmitting and/or receiving dipole has a width which is essentially equal to the width of the first transmitting and/or receiving dipole. Further reduction of the wave resistance is achieved by using this design. Power may be supplied in this case by using two micro striplines.

The dimensions of the two transmitting and/or receiving dipoles and the distance between the first transmitting and/or receiving dipole and the second transmitting and/or receiving dipole essentially depend on the employed frequency, the distance varying in inverse proportion to the frequency. In the frequency range of 76 GHz to 81 GHz discussed here, the distance between the first transmitting and/or receiving dipole and the second transmitting and/or receiving dipole is between 200 μm and 300 μm, in particular 250 μm.

It is understood that the present invention is not limited to the frequency range of 76 GHz to 81 GHz, but may be extended to other frequency ranges, in which case the dimensions are appropriately scaled as a function of the frequency, i.e., for example, by adapting the distance between the two transmitting and/or receiving dipoles and the dimensions of the antennas to the frequency.

### DESCRIPTION OF THE DRAWINGS

FIG. 1 schematically shows a section of the radar transceiver in a single-chip design having an antenna system according to the present invention.

FIG. 2 shows the system of a plurality of radar transceivers illustrated in FIG. 1.

FIG. 3 shows another exemplary embodiment of a radar transceiver in a single-chip design, together with an antenna system according to the present invention in which the chip of the radar transceiver is situated on a substrate in flip chip technology.

FIG. 4 shows four side-by-side radar transceivers illustrated in FIG. 3.

FIG. 5 shows another exemplary embodiment of a radar transceiver in a single-chip design, together with an antenna system according to the present invention in which the chip of the radar transceiver is situated on a substrate in flip chip technology.

FIG. 6 shows four side-by-side radar transceivers illustrated in FIG. 5.

FIG. 7a schematically shows an antenna system for a radar transceiver according to the present invention.

FIG. 7b shows the antenna system depicted in FIG. 7a with the radome removed.

FIG. 7c shows the antenna system depicted in FIG. 7b having a second transmitting/receiving dipole (not depicted).

FIG. 8 schematically shows the system of the first transmitting and/or receiving dipole and the second transmitting/receiving dipole on one chip.

### DETAILED DESCRIPTION

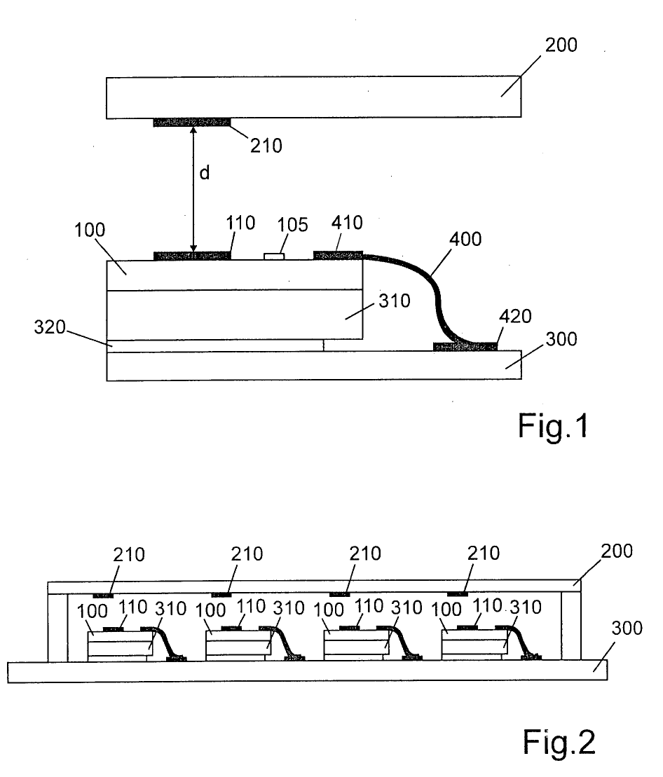

In a radar transceiver depicted in FIG. 1, not only all transmitting/receiving devices 105 of the transceiver, but also an antenna system explained in greater detail below, are situated on one SiGe chip 100. A dipole having a parallel wire feed, i.e., a differential feed line, is provided on the chip. Dipole 110 is operated with a voltage feed in order to be able to achieve high impedances.

A second part of antenna 210 is situated at a distance d from the first part of antenna 110 on a radome 200. If this second part of antenna 210 is situated at a distance of approximately 250 μm on a 300 μm thick radome, the wave resistance drops to approximately 800 Ohm. This radome is simultaneously used as a housing, chip 100 being completely encapsulated, as is apparent in particular from FIG. 2, where four radar transceivers of this type are situated side-by-side on a substrate board 300. The active microwave layer of SiGe chip 100, which has a thickness of approximately 11 μm, is situated on a silicon substrate 310, which is attached to a substrate 300 via an intermediate layer 320, known as an underfiller. The entire system is here connected by bond wires 400, which an electrical conductor between bond patches 410 situated on SiGe chip 100 and bond patches 420 situated on substrate 300.

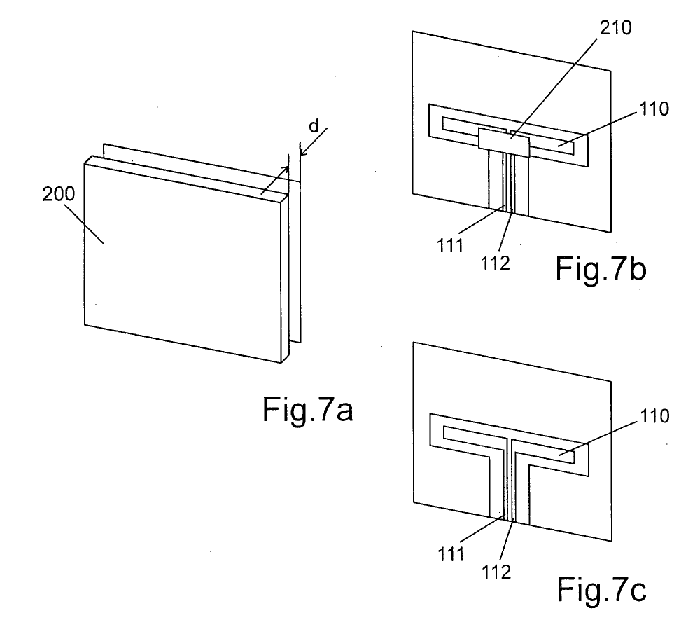

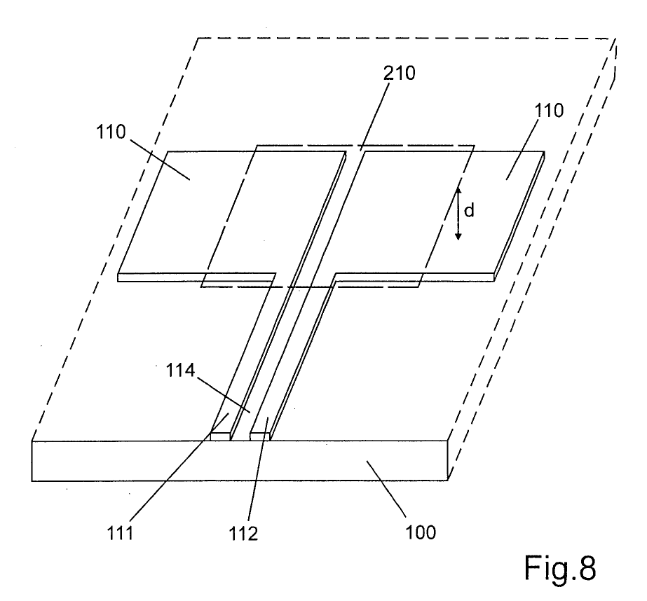

FIGS. 7a, 7b and 7c schematically depict the antenna system. In the schematic illustration of FIG. 7a, radome 200 covers the antenna system. Second antenna 210 situated on radome 200 has a distance d from first antenna 110 (see FIG. 7b). First antenna 110 is fed via a dual-wire line 111, 112 (see FIG. 7c and FIG. 8). The feed is designed for 50 Ohm, for example. In a first approximation, it is designed to be frequency-independent. For an 11 μm thickness of the microwave layer, the width of the track conductor is preferably approximately 20 μm. Gap 114 between the two track conductors is also approximately 20 μm. If the layer thickness of the active microwave layer of chip 100 is only 5 μm, for example, a width of approximately 10 μm of track conductors 111, 112 and a gap 114 of approximately 10 μm are selected. The spacings may be determined with the aid of essentially known circuit simulators or field simulators or also by using measurement technology.

The second part of antenna 210 situated on radome 200 is, as FIGS. 7b, 7c, and 8 show, an uninterrupted dipole having a length of one-half of a wavelength of the transmitted/received electromagnetic waves. For proper field coupling, it has approximately the same width as the full-wave dipole on SiGe chip 100. This design reduces the wave resistance to 100 Ohm. In this way, first transmitting/receiving dipole 110 may be fed using 50-Ohm micro striplines, whose width and spacing are 20 μm for a height of 11 μm of the SiGe chip.

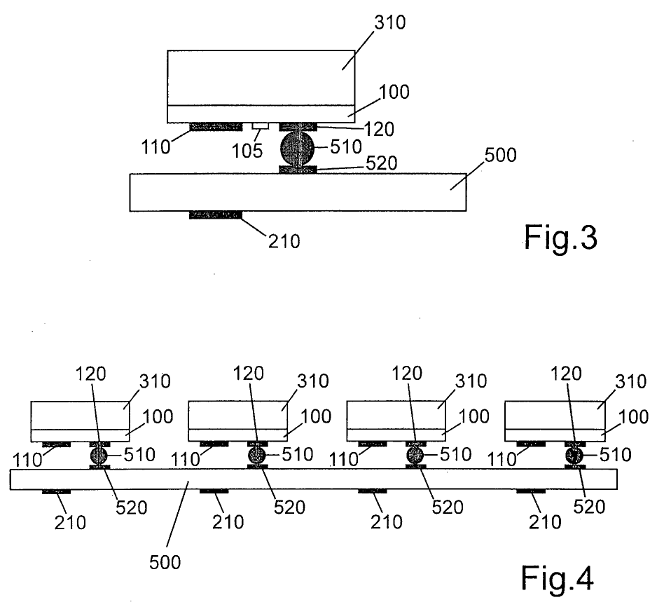

FIGS. 3 and 4 show a SiGe chip system 100 in flip chip technology. SiGe chip 100 is situated on a silicon substrate 310. Instead of bond patches 410, it has contact surfaces 120, which are contacted in flip chip technology via a solder point 510 on contact surfaces 520. Contact surfaces 520 are situated on a substrate 500. The first part of antenna 110, i.e., first transmitting/receiving dipole 110, is in turn situated on SiGe chip 100. The second part of the antenna, i.e., second transmitting/receiving dipole 210, is in this case situated on the side of substrate 500 facing away from SiGe chip 100. Substrate 500 must be made of a material which allows electromagnetic waves of very high frequencies in the microwave range to pass through.

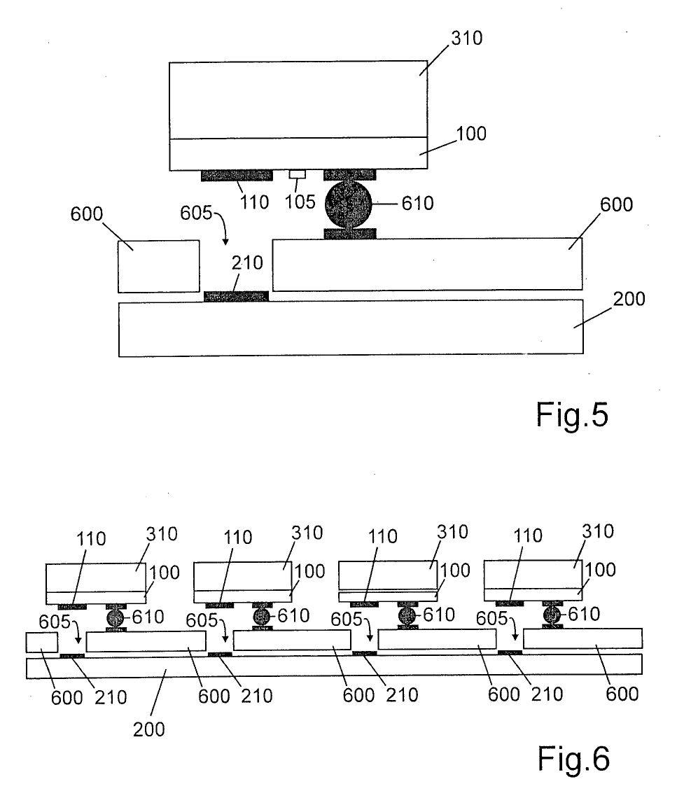

In another exemplary embodiment depicted in FIGS. 5 and 6, the same elements as in FIGS. 3 and 4 are provided with the same reference numerals, so that reference is made to the above for their description. Unlike the exemplary embodiment depicted in FIGS. 3 and 4, the exemplary embodiment depicted in FIGS. 5 and 6 represents a flip chip design, in which a low-frequency substrate 600 is provided, having openings 605, and which is no longer necessarily transparent to electromagnetic waves of very high frequencies and is therefore more economical, on which contact surfaces 620 are provided for the flip chip placement of SiGe chip 100 situated on silicon substrate 310 via solder points 610. Second transmitting/receiving dipoles 210 are situated in openings 605 of low-frequency substrate 600, for example, on a radome 200 or on a housing.

The advantages of the above-described antenna system lie in a high bandwidth, which is implemented by full-wave excitation using a differential feed. Another advantage is that radome 200 may be used as a housing capsule, so that the entire system is tight and tolerance-insensitive to water/dew. In addition, no junctions from chip 100 to the substrate are needed at the operating frequency (high frequency), but contacting is achieved via bond wires or via flip chip contacting in the low-frequency range. Differences in the expansion coefficients may be compensated for via intermediate layer 320, the so-called underfiller, so that a reliable attachment of SiGe chip 100, which represents the actual radar transceiver, to substrate 300 results.

Contacting via bond wires 400 may be performed prior to encapsulating. In the case of the exemplary embodiment depicted in FIGS. 3 through 6, the substrate may also have antenna structures. In addition, the area under the antenna may be used for heating.

The antenna system described above was elucidated with reference to a SiGe chip 100. It is understood, however, that the present invention is not limited to chips in silicon-germanium technology, but may also be used with SiGeC chips or BiCMOS chips or SiC chips.

1-11. (canceled)

12. An antenna system for a radar transceiver comprising:
at least one antenna situated on a chip, which includes at least one part of transmitting and receiving units of the radar transceiver, the at least one antenna including a first part situated on the chip and a second part situated at a distance from the first part, the second part being radiation-coupled to the first part.

13. The antenna system according to claim 12, wherein the antenna system is for ascertaining at least one of a distance and a velocity in surroundings of a motor vehicle.

14. The antenna system according to claim 12, wherein the second part of the antenna is situated on a radome.

15. The antenna system according to claim 14, wherein the radome forms a housing which completely encapsulates the chip.

16. The antenna system according to claim 12, wherein the first part is a first transmitting/receiving dipole, and the second part is a second transmitting/receiving dipole.

17. The antenna system according to claim 16, wherein the first transmitting/receiving dipole has two halves separated by a gap.

18. The antenna system according to claim 17, wherein a differential or symmetric feed of the first transmitting/receiving dipole is provided.

19. The antenna system according to claim 16, wherein the first transmitting/receiving dipole has a length about equal to a wavelength of emitted/received electromagnetic radiation.

20. The antenna system according to claim 16, wherein the second transmitting/receiving dipole is one of an uninterrupted continuous dipole and a surface radiator.

21. The antenna system according to claim 20, wherein the second transmitting/receiving dipole has a length about equal to one-half of a wavelength of emitted/received electromagnetic radiation.

22. The antenna system according to claim 20, wherein the second transmitting/receiving dipole has a width which is about equal to a width of the first transmitting/receiving dipole.

23. The antenna system according to claim 16, wherein a distance between the first transmitting/receiving dipole and the second transmitting/receiving dipole is between 200 μm and 300 μm, in a frequency range of 76 GHz to 81 GHz.

24. The antenna system according to claim 23, wherein the distance is about 250 μm.
